(19) United States
(12) Patent Application Publication
(10) Pub. No.: US 2019/0135220 A1
(43) Pub. Date: May 9, 2019

(54) LARGE VOLUME DUAL AIRBAG SYSTEM

(71) Applicant: NIO USA, Inc., San Jose, CA (US)

(72) Inventors: Jeffrey D. Rupp, San Jose, CA (US); Bruno M. Barthelemy, Los Gatos, CA (US)

(21) Appl. No.: 15/806,624

(22) Filed: Nov. 8, 2017

(51) Int. Cl. B60R 21/231; B60R 21/205; B60R 21/235; B60R 21/239; B60R 21/015; B60R 21/2155

(52) U.S. Cl. CPC B60R 21/231; B60R 21/205; B60R 21/235; B60R 2021/161; B60R 21/01512; B60R 21/2155; B60R 2021/23107; B60R 21/239

(57) ABSTRACT

A large volume between a vehicle occupant and a vehicle structure positioned in front of the vehicle occupant can be filled by two airbags, the first arranged to deploy between the vehicle occupant and the vehicle structure and the second arranged to deploy between the first airbag and the vehicle structure. One or both of the airbags can be configured to deploy in a non-linear path that reduces the risk of injury to the vehicle occupant (particularly if the vehicle occupant is out of position) by the deployment itself.

### FIELD

The present disclosure is generally directed to vehicle systems, and more particularly to vehicle airbag systems.

### BACKGROUND

The inclusion of airbags in passenger vehicles has largely become standard, in many cases due to government safety regulations. Airbags have proven effective at protecting vehicle occupants from more serious injury when the occupied vehicle is involved in a crash. This is due in large part to the ability of airbags to deploy quickly, thus enabling protection of occupants even during crashes that occur at high speeds. When deployed, airbags help to prevent vehicle occupants from excessive movement within the vehicle passenger compartment and associated injuries.

Current vehicle technology provides a single passenger airbag for protection of a vehicle passenger in the event of a frontal crash. Significant injuries to legs and feet often occur in a frontal crash due to the design and rigidity of the instrument panel. Additionally, the passenger airbag can injure an occupant of the passenger seat that is not in a normal seating position during deployment of the airbag (an “out-of-position occupant”).

U.S. Pat. No. 6,431,583, entitled “Inflatable Knee Bolster with External Tethering” and filed on Feb. 28, 2001, discloses a knee airbag system configured to be disposed in an instrument panel of a vehicle. U.S. Pat. No. 6,962,363, entitled “Multiple Chamber Airbags and Methods” and filed on Jul. 6, 2001, discloses a two or more chambered airbag that provides improved safety and/or performance. U.S. Pat. No. 7,070,201, entitled “Low Risk Deployment Passenger Airbag System” and filed on Aug. 2, 2004, discloses a passenger airbag system with a top-mounted airbag without substantial downward deployment and a mid-mounted airbag without substantial upward deployment. U.S. Pat. No. 9,248,799, entitled “Dual Cushion Airbag with Independent Inflation” and filed on Jun. 3, 2014, describes an airbag assembly for inflating a first airbag and a second airbag. Each of the foregoing references is hereby incorporated herein, in its entirety, by reference.

### BRIEF DESCRIPTION OF THE DRAWINGS

FIG. 1 shows a vehicle in accordance with embodiments of the present disclosure;

FIG. 2A shows a passenger compartment of a vehicle such as the vehicle shown in FIG. 1 in accordance with embodiments of the present disclosure, in a first configuration;

FIG. 2B shows the passenger compartment of FIG. 2A, in a second configuration;

FIG. 3A shows a side elevational view of a portion of a passenger compartment of a vehicle according to one embodiment of the present disclosure;

FIG. 3B shows a top plan view of the passenger compartment of FIG. 3A;

FIG. 4A shows a side elevational view of an airbag according to another embodiment of the present disclosure, in a stowed configuration;

FIG. 4B shows a top plan view of the airbag of FIG. 4A, in the stowed configuration;

FIG. 4C shows a top plan view of the airbag of FIG. 4A, in a partially deployed configuration;

FIG. 4D shows a top plan view of an airbag according to another embodiment of the present disclosure, in a partially deployed configuration;

FIG. 5A shows a side elevational view of a portion of the passenger compartment of a vehicle according to still another embodiment of the present disclosure; and

FIG. 5B shows a top plan view of the passenger compartment of FIG. 5A.

### DETAILED DESCRIPTION

Embodiments of the present disclosure will be described in connection with a vehicle, and more particularly with respect to an automobile. However, for the avoidance of doubt, the present disclosure encompasses the use of the aspects described herein in vehicles other than automobiles.

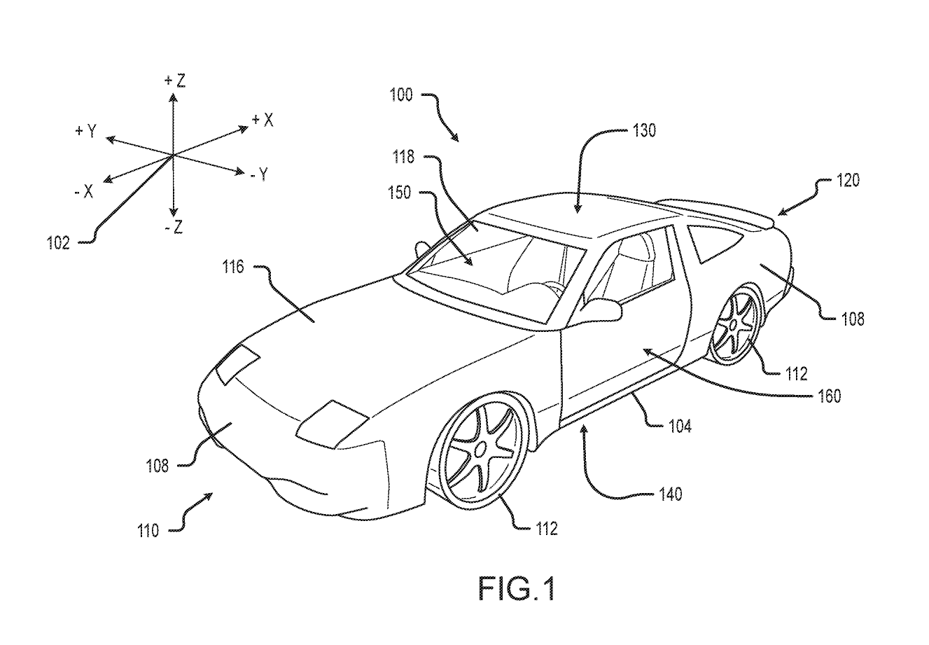

FIG. 1 shows a perspective view of a vehicle 100 in accordance with embodiments of the present disclosure. The vehicle 100 comprises a vehicle front 110, vehicle aft 120, vehicle roof 130, at least one vehicle side 160, a vehicle undercarriage 140, and a vehicle interior 150. The vehicle 100 may include a frame 104, one or more body panels 108 mounted or affixed thereto, and a windshield 118. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Coordinate system 102 is provided for added clarity in referencing relative locations in the vehicle 100. In this detailed description, an object is forward of another object or component if the object is located in the −X direction relative to the other object or component. Conversely, an object is rearward of another object or component if the object is located in the +X direction relative to the other object or component.

The vehicle 100 may be, by way of example only, an electric vehicle or a gas-powered vehicle. Where the vehicle 100 is an electric vehicle, the vehicle 100 may comprise one or more electric motors powered by electricity from an on-board battery pack. The electric motors may, for example, be mounted near or adjacent an axis or axle of each wheel 112 of the vehicle, and the battery pack may be mounted on the vehicle undercarriage 140. In such embodiments, the front compartment of the vehicle, referring to the space located under the vehicle hood 116, may be a storage or trunk space. Where the vehicle 100 is a gas-powered vehicle, the vehicle 100 may comprise a gas-powered engine and associated components in the front compartment (under the vehicle hood 116), which engine may be configured to drive either or both of the front wheels 112 and the rear wheels 112. In some embodiments where the vehicle 100 is gas-powered, the gas-powered engine and associated components may be located in a rear compartment of the vehicle 100, leaving the front compartment available for storage or trunk space or for other uses. In some embodiments, the vehicle 100 may be, in addition to a battery-powered electric vehicle or a gas-powered vehicle, a hybrid electric vehicle, a diesel-powered vehicle, or a fuel cell vehicle.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, buses, automobiles, trains, railed conveyances, boats, ships, marine conveyances, submarine conveyances, airplanes, space craft, flying machines, human-powered conveyances, and the like.

Before describing the remaining figures, some airbag applications could benefit from the use of a passenger airbag having a larger volume than any passenger airbag that is currently available. For example, in autonomous vehicles, or vehicles having an increased interior cabin space and/or distance between an occupant and an airbag deployment location, conventional airbag systems are unable to deploy quickly enough while providing the same level of safety and protection to the occupant.

Scaling up the size of passenger airbags, however, results in certain safety challenges. For instance, in order to inflate quickly, a large-volume airbag would require a higher explosive force to fill the large-volume airbag in time to protect an occupant. Because volume is a cubic function, the explosive force required to fill a larger bag may be required to increase substantially. Additionally, the deployment speed of large volume airbags may need to be higher than the deployment speed of airbags currently in use, in order to fill the large-volume airbag in the required amount of time. The use of a greater explosive force and a faster deployment speed increases the risk of injury to a vehicle occupant, and especially to an out-of-position vehicle occupant (e.g., an occupant that is not seated in a seat with both feet on the vehicle floor), during airbag deployment. Because the airbag must initially be stored in a small volume, the greater explosive force and high speed of deployment combined with the small size of the airbag during the initial moments of deployment could result in a concentrated force being exerted on an out-of-position occupant if the airbag is deployed in an area where the out-of-position occupant is located, possibly causing serious injury.

Additionally, a vehicle in which an occupant could place his or her legs near or against an instrument panel surface without risking significant or life-threatening injuries during a crash would be beneficial.

Embodiments of the present disclosure reduce the risk of injury to a vehicle occupant while maintaining occupant safety and protection, even in a vehicle with larger than normal amounts of space to be filled, by providing a large volume dual airbag system in which a first airbag is deployed into the space immediately in front of the vehicle occupant at a reduced force/pressure, while a second airbag is deployed at a reduced force/pressure into the space between the first airbag and the instrument panel (or forward vehicle wall), so as to support the first airbag and provide for force transmission from the first airbag through the second airbag to the instrument panel or forward vehicle wall.

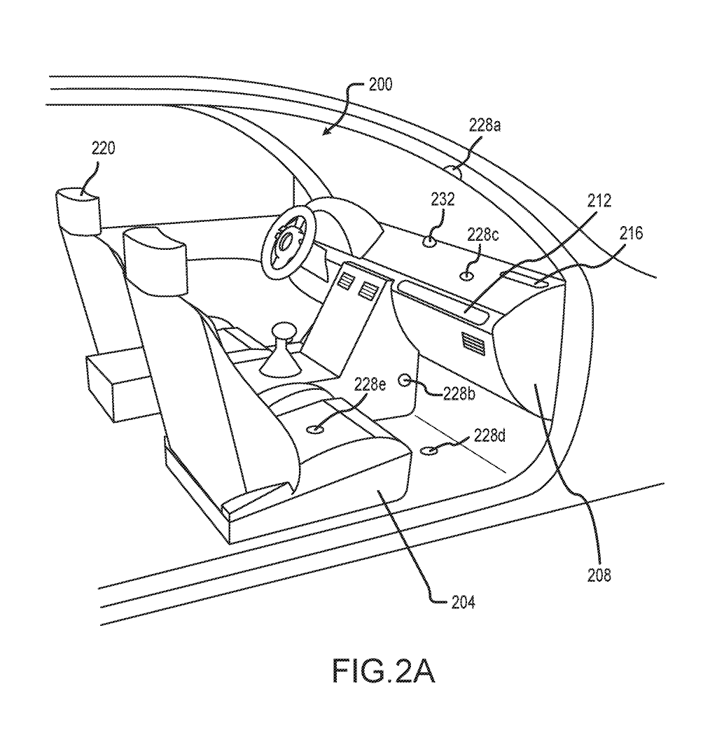

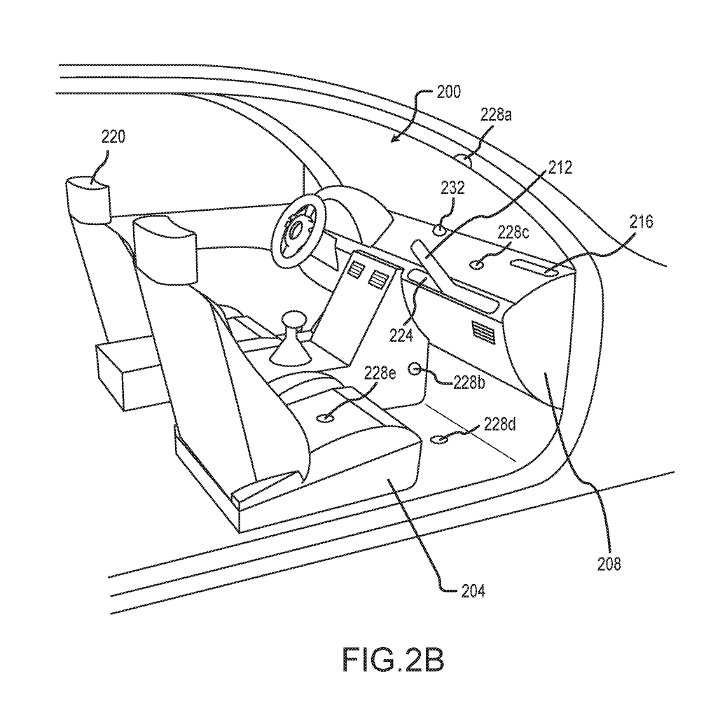

With reference now to FIG. 2A, a passenger compartment 200 of the vehicle 100 comprises a passenger seat 204, an instrument panel or dashboard 208, and a driver's seat 220. Breakaway panels 212 and 216 on the instrument panel 208 cover airbag modules positioned to deploy a plurality of airbags into the passenger compartment 200 in the event of a collision. A plurality of sensors 228 are positioned to detect the position of one or more vehicle occupants as well as other objects that are not part of the vehicle 100.

The breaking away or opening of the panels 212 and 216 may result from a controlled explosion or other rapid expansion of gas that exerts sufficient force on the panels 212 and 216 to cause the panels 212 and 216 to break away or open. Additionally or alternatively, the breaking away or opening of the panels 212 and 216 may result from the impact of a folded airbag that is ejected from an airbag module toward the panels 212 and 216. As another alternative, the breaking away or opening of the panels 212 and 216 may be caused by a device or mechanism other than an airbag or an airbag module. For example, a pre-loaded spring may be located underneath one or both of the panels 212 and 216, and a release mechanism may be used to release the spring upon detection of an imminent or actual collision, such that the spring releases its stored energy and pushes (or pulls, or otherwise exerts a force on) one or both of the panels 212 and 216, thus causing the panel 212 or 216 to break away or otherwise open.

In some embodiments, one or both of the breakaway panels 212 and 216 may be configured to break away or otherwise open in a controlled manner. For example, the breakaway panel 212 may be configured to open in a rolling manner, beginning on a side proximate the driver's seat 220 and opening toward a side distal the driver's seat 220, as shown in FIG. 2B. Controlling the opening of the panel 212 beneficially allows the panel 212 to push any object (including, for example, a person's feet and/or legs) that is resting on the instrument panel 208 to the side of the instrument panel 208, and out of the way of the soon-to-be-deployed airbag. This in turn reduces the risk of injury to an occupant of the passenger compartment 200 in the area of the passenger seat 204. As the panel 212 opens, it uncovers a cavity or space 224 in which a passenger airbag module (or components thereof) are stored, or through which a passenger airbag may be deployed. The panels 212 and 216 may be configured to always open in a controlled manner to sweep feet, legs, or other objects to the side before full deployment of the airbag stored underneath or behind the panels 212 and 216 toward a vehicle occupant.

Also shown in FIGS. 2A to 2B are a plurality of sensors 228. The sensors are positioned, by way of example and not limitation, on the door frame (sensor 228a), on the center console (sensor 228b), on the instrument panel (sensor 228c), on the passenger compartment floor (sensor 228d), and on the passenger seat 204 (sensor 228e). Any particular embodiment of the present disclosure that is configured with sensors 228 may comprise more or fewer sensors, which may be located in one or more of the locations identified above, and/or in other locations.

The sensors 228 are configured to measure and/or detect conditions suggesting or indicative of the location of foreign objects (meaning objects that are not part of the vehicle, and including occupants thereof) within the portion of the passenger compartment 200 into which one or more passenger airbags would deploy. The sensors 228 are connected to a processor (not shown) that is configured to execute instructions (which may be stored, for example, in a computer-readable memory) that cause the processor to receive one or more signals from one or more sensors 228; analyze the one or more signals to identify a foreign object; determine a likely position of the foreign object; and, based on the determination, selectively cause a passenger airbag not to deploy or to deploy in a non-standard manner. For example, the processor may cause the passenger airbag to deploy only partially. This may be accomplished, for example, by utilizing an airbag that comprises a plurality of compartments, and by causing fewer than all of the compartments to inflate upon deployment of the airbag. In embodiments that employ sensing as described herein, the sensors 228 beneficially allow a processor of the vehicle 100 to modify the deployment of a passenger airbag to reduce the likelihood of causing injury to an occupant of the vehicle 100, and/or to increase the protection provided by the passenger airbag to the vehicle occupant.

One or more of the sensors 228 may be a pressure sensor or other sensor for detecting or measuring weight. For example, one or more of the sensors 228c, 228d, and 228e may be configured to detect pressure resulting from the weight of an occupant of the passenger seat 204. If the occupant places a foot or feet on the instrument panel 208, for example, then the sensor 228c will detect a greater than typical pressure, and can send a signal to a processor corresponding to the detected or measured pressure. The use of sensors 228 to detect or measure pressure on the instrument panel 208, the floor, and the passenger seat 204 may beneficially allow the processor to adjust the deployment of a passenger airbag in a more specific or more tailored manner. For example, the processor may cause the passenger airbag or passenger airbags not to deploy, or to deploy at a faster or slower rate, or to only partially deploy. The processor may adjust also the shape of inflation of a passenger airbag (e.g., by causing different compartments of the airbag to inflate or not to inflate). The processor may control these variables by, for example, triggering or not triggering one or more of a plurality of initiators or inflators operably connected to an airbag (whether to adjust the rate of inflation of the airbag to or to cause only certain compartments of a multi-compartmented airbag to inflate); causing or not causing one or more tethers configured to control the shape of the inflated airbag to be severed or released; and/or causing or not causing one or more supports, tethers, or other devices to be severed or released, so as to control a deployment path of the airbag.

Other types of sensors 228 may also be used within the scope of the present disclosure. For example, sensors 228a and 228b may be ultrasonic sensors, radar sensors, and/or lidar sensors, configured to detect the presence and/or position of one or more foreign objects in the area between the passenger seat 204 and the instrument panel 208. One or more of the sensors 228a and 228b may also be or comprise a camera or other optical sensor. Regardless of the type or types of sensor used for the sensors 228, the purpose of the sensors 228 remains as described above (e.g., to facilitate the adjustment of the deployment of a passenger airbag to reduce the risk of injury to a vehicle occupant and/or to increase the protection of the vehicle occupant).

In some embodiments, the vehicle 100 may be provided with a sensor 232 configured to detect information useful for determining whether a collision between the vehicle 100 and another object is imminent. Such a sensor 232 may be mounted within the passenger compartment 200 or elsewhere on the vehicle 100. In some embodiments, the sensor 232 may be or comprise a radar sensor, a lidar sensor, an ultrasonic sensor, an optical sensor, or other sensors. As with the sensors 228, the sensor 232 is configured to send one or more signals to a processor. If the processor determines, based upon the one or more signals received from the sensor 232, that a collision is imminent and inevitable, then the processor may cause the passenger airbag system (and/or other airbag or safety systems of the vehicle 100) to begin deployment before the collision. In such embodiments, the deployment of the passenger airbag system can occur more slowly (and therefore with less force, and less risk of injury to an out-of-position occupant) than if the passenger airbag system were to deploy only after detection of an actual collision. Also in such embodiments, the processor may cause the passenger airbag system to deploy at a slower than usual rate (where the usual rate is the rate of deployment when deployment begins after detection of a collision). This may be accomplished, for example, by causing fewer than all of the inflators attached to the passenger airbag system to ignite or otherwise operate.

Although the breakaway panels 212 and 216 and the sensors 228 and 232 are shown in the embodiment of FIGS. 2A-2B, in some embodiments a vehicle 100, and more specifically a passenger compartment 200, may comprise one or more breakaway panels such as the breakaway panels 212 and 216—one or more of which may be configured to open in a controlled fashion to sweep feet, legs, or other objects to the side before full deployment of an airbag toward an occupant—without including any sensors 228 or 232. In other embodiments, a passenger compartment 200 may comprise one or more sensors such as the sensors 228 or 232, but may not include any breakaway panels configured to open in a controlled fashion, such as the breakaway panels 212 and 216. In other words, the sensors 228 and 232 are not necessary for the proper operation of the breakaway panels 212 and 216, and vice versa.

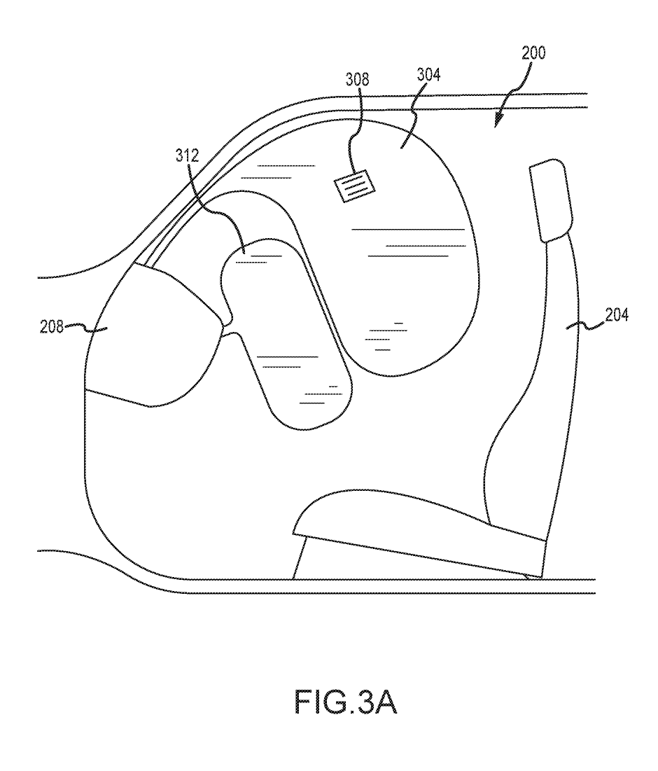

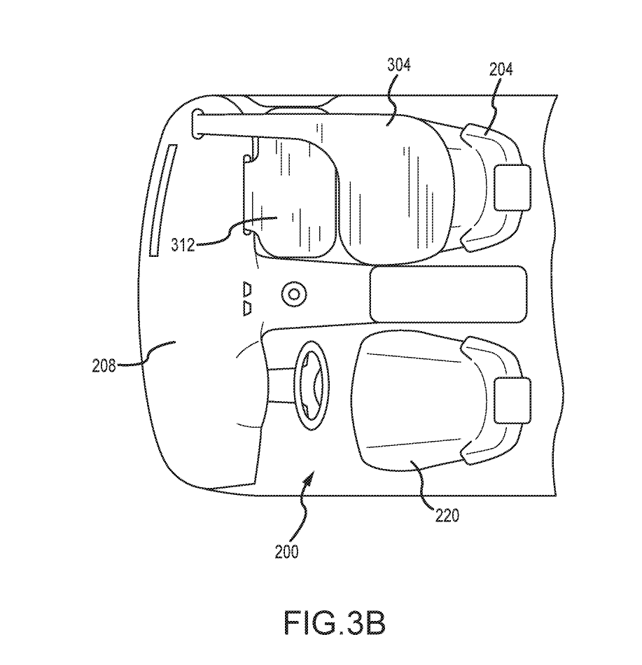

Turning now to FIGS. 3A and 3B, a large volume dual airbag system according to one embodiment of the present disclosure comprises a first airbag 304 and a second airbag 312, each configured to deploy into the passenger compartment 200 of a vehicle 100. In some embodiments, such as that illustrated in FIGS. 3A-3B, the airbags 304 and 312 are configured to deploy from the instrument panel 208, into the space between the instrument panel 208 and the passenger seat 204. In other embodiments, one or both of the airbags 304 and 312 may be configured to deploy from another location within the vehicle 100, such as from a door frame of a passenger-side door to the vehicle 100; from a center console positioned between the driver's seat 220 and the passenger seat 204; from a forward wall of the passenger compartment 200 (e.g., in a vehicle 100 that does not comprise an instrument panel that extends in front of the passenger seat 204, or beneath an instrument panel such as the instrument panel 208); or from a side of the passenger seat 204.

The dual airbag system of FIGS. 3A-3B deploys in a sequenced manner intended to protect an occupant of the passenger seat 204 from harm due to a frontal crash or other collision, while also reducing the risk of injury to the occupant from deployment of the airbags 304 and 312. The airbag 304 deploys first, with an initial upward trajectory that causes the airbag to deploy along a front windshield of the vehicle 100 before transitioning to a rearward trajectory (e.g., toward the passenger seat 204) and expanding downward into the space in front of the passenger seat 204. By deploying in this manner, the airbag 304 avoids placing a load on the feet, legs, and/or knees of an occupant, who may have one or both of his or her legs or feet in an elevated position (whether resting on the instrument panel 208 or not). Although the airbag 304 does not deploy directly toward the passenger seat 204, the airbag 304 does deploy quickly, so as to quickly protect an occupant of the passenger seat 204 and to reduce the energy impulse effect.

In some embodiments, the airbag 304 may deploy in a manner that pushes objects or out-of-position occupants out of the way of the to-be-deployed airbag 312. For example, the airbag 304 could deploy across an instrument panel before expanding upward along a front windshield and then rearward and downward into the space immediately in front of an occupant of the passenger seat 204. Additionally or alternatively, a breakaway panel or other covering that hides the airbag module containing the airbag 304 during normal operation of the vehicle 100 may be configured to break away or otherwise open in a manner that sweeps, urges, pushes, or otherwise moves an object (whether an extremity of a vehicle occupant or another object) off of the instrument panel 208 and/or away from the deployment path of the airbag 312.

As shown in FIG. 3B, the airbag 304 may also deploy from a side of the instrument panel 208 rather than from directly in front of the passenger seat 204, although the fully expanded airbag 304 still extends directly in front of the passenger seat 204. By deploying the airbag 304 from a side of the instrument panel 208, the risk of injury to an occupant with feet or legs on the instrument panel 208 directly in front of the occupant may be further reduced.

The airbag 312 reaches full deployment after the airbag 304. In some embodiments, the airbag 312 does not begin to deploy until after the airbag 304 is already fully inflated. In other embodiments, the airbag 312 begins to deploy at the same time or shortly after initial deployment of the airbag 304, but the airbag 312 deploys more slowly than the airbag 304. A slower deployment beneficially means the airbag 312 will impose a lighter load on any lower extremities of an occupant of the passenger seat 204 (whether such lower extremities are in a standard, feet-on-the-floor position or in a raised or other non-standard position), to the extent the airbag 312 impacts such extremities. Additionally, a delay in deployment or a slower deployment may beneficially allow a breakaway panel such as the panel 212 to breakaway in a controlled manner that moves the occupant's feet and/or legs away from the deploying airbag 312.

As shown in FIG. 3A, the airbag 312 may deploy toward the passenger seat 204. In other embodiments, the airbag 312 may initially deploy in an upward direction, above the legs and feet of an occupant, so as not to engage (or so as to minimize engagement) with the legs and feet during initial deployment (e.g., as the airbag 312 is being ejected from a storage canister). Regardless of the direction of initial deployment, the airbag 312 inflates into a volume in between the volume occupied by the first airbag 304 and a vehicle surface (in FIGS. 3A and 3B, the surface of the instrument panel 208) so as to provide support in the longitudinal direction (e.g., along the X-axis, as defined by the coordinate system 102 of FIG. 1) for the airbag 304. The dual airbag system is designed to ensure that the airbag 312 reaches full deployment as the airbag 304 is being pushed forward by an occupant of the passenger seat 204. In the event of a frontal collision that causes the airbags 304 and 312 to deploy, an occupant of the passenger seat 204 will impact the airbag 304, which will absorb some of the force of impact while transferring some of that force to the airbag 312, which likewise will absorb some of the force while transferring some of the force to the instrument panel 208.

The airbag 304 is provided with a vent 308 that allows the airbag to deflate somewhat when impacted by a vehicle occupant, so as to dissipate some of the energy of the impact and soften the force felt by the occupant of the seat 204 as the occupant strikes the airbag 304. The airbag 312, on the other hand, does not have to absorb the energy from a direct impact from a vehicle occupant (because of the position of the airbag 312 between the airbag 304 and the instrument panel 208), and so may not be provided with a vent (or may be provided with only a small vent), so as to ensure a longer stand-up time (and therefore to ensure that the airbag 312 provides support for the airbag 304 while the airbag 304 is inflated).

In some embodiments, the airbag 304 may be configured to deploy in a way that moves an out-of-position occupant or other object out of the deployment path of the airbag 312 (or vice versa). This may be accomplished, for example, by configuring the airbag 304 (or the airbag 312) to inflate across the volume (or a portion thereof) into which the airbag 312 (or across the volume through which the airbag 304) will deploy, beginning from the side or top of the volume, rather than directly into that volume (e.g., from the point of deployment toward the passenger seat 204). For example, the airbag 304 (or the airbag 312) could extend or unroll rearward along a side window of the vehicle 100, then fill or inflate in a lateral direction, across the space in front of the passenger seat 204. Alternatively, the airbag 304 (or the airbag 312) could unroll in a lateral direction and then fill or inflate rearward. In either example, the lateral motion moves feet, legs, or other objects away from the direct line of contact between the forward moving occupant and the quickly stiffening line of reaction from the airbag 304 to the airbag 312 to the instrument panel 208. Also in some embodiments, the airbag 304 (or the airbag 312) may deflect off of an out-of-position occupant, and the airbags 304 and 312 may only reach full deployment when the airbag 312 is deployed following a time delay after deployment of the airbag 304 (or vice versa).

Although the airbags 304 and 312 of the embodiment of FIGS. 3A and 3B are disclosed as deploying first and second, respectively, in other embodiments the airbag 312 may deploy before the airbag 304. For example, the airbag 312 may deploy first to move any feet, legs, or other objects away from immediately in front of the dash panel 208, and the airbag 304 may then deploy.

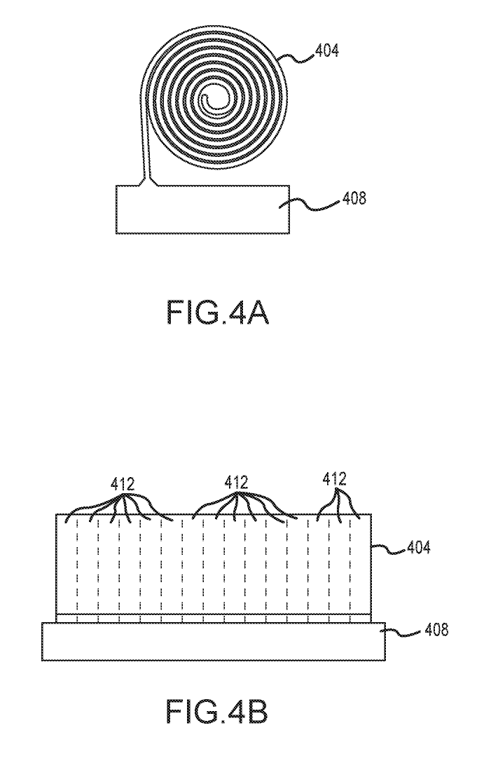

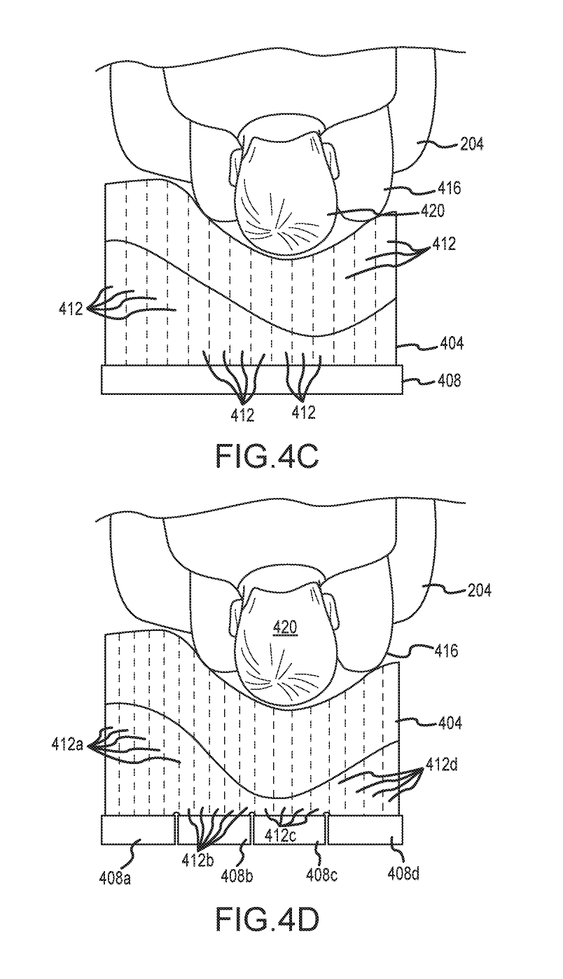

Turning now to FIGS. 4A-4D, an airbag 404 according to another embodiment of the present disclosure may be stored in a rolled, folded, or otherwise compacted position, and may be operably connected to an inflation mechanism 408 configured to inject gas into the airbag 404 in the event of a collision. (The airbag 404 may be configured to protect a vehicle occupant in the event of a frontal collision, but airbags intended for use in other types of collisions are also encompassed within the scope of the present disclosure.) The airbag 404 may be used, for example, in the same manner as the airbag 312 described above, as the second airbag to deploy in a large-volume dual airbag system.

The airbag 404 may comprise a plurality of tubes 412, with each tube 412 defined by interior walls (shown as dashed lines in FIGS. 4B-4D) that separate one tube 412 from another tube 412. Moreover, the injection of gas into the tubes 412 by the inflation mechanism 408 may cause the airbag 404 to unroll (or unfold or otherwise expand from a compacted original position). If a portion of the expanding airbag encounters a knee 416 or a head 420 of an occupant of a passenger seat 204, or any other extremity of such an occupant or other object that does not readily give way to the expanding airbag, however, then the pressure required to continue to unroll or otherwise unfold that portion of the airbag 404 will rise significantly. The tubes 412 of the airbag 404 in the portions of the airbag 404 that have not encountered any obstacle will therefore become the path of least resistance for the gas entering the airbag 404, and so those portions of the airbag 404 will continue to expand while the blocked tubes 412 of the airbag 404 remain uninflated (as shown in FIG. 4C). In this manner, the airbag 404 can be configured to inflate around an out-of-position occupant or other object, rather than simply pushing the out-of-position occupant or other object out of the path of the expanding airbag.

The inclusion of tubes 412 in an airbag 404 (together with, in some embodiments, the rolling or folding of the airbag 404 so that inflation of one or more tubes 412 will be impeded if the airbag 404 cannot be unrolled or unfolded due to an obstacle in the path of the airbag 404) beneficially reduces the energy impulse effect on an out-of-position occupant. More specifically, the inclusion of the tubes 412 results in a more controlled inflation of the airbag 404, and inflation of one or more tubes 412 of the airbag 404 can be blocked relatively easily, even while the remainder of the airbag 404 continues to inflate. In contrast, an airbag without tubes 412 or other internal compartments will expand indiscriminately, and is more likely to exert a pushing force (which may be significant) on any obstacle encountered by the airbag during inflation.

Although the tubes 412 are depicted as internal compartments of a single airbag 404 in FIGS. 4A-4C, in some embodiments the tubes may or may not be connected to each other, and, if connected, the extent of connection may vary. For example, the tubes may be stitched in one or a few discrete points, or stitched together with small tethers between each of the tubes so that each tube can move relative to adjacent tubes freely or even in a limited fashion. Such an arrangement beneficially reduces the likelihood that an inflating tube might “drag along” an immediately adjacent tube (which immediately adjacent tube might be in a lower pressure state than the inflating tube, but may still prevent an airbag 404 from filling in a manner that adapts to the shape of an obstacle encountered by the airbag during the inflation process. In some embodiments, then, each tube may be rolled or folded, and may unfurl or unfold, independently, with those that are not prevented from unfurling or unfolding due to early contact with an out-of-position occupant, appendage, or other object inflating fully, and those that are prevented from unfurling or unfolding due to early contact with an out-of-position occupant, appendage or other object inflating only partially or not at all. Additionally, while the tubes 412 in FIGS. 4A-4D are all aligned in the same direction, in some embodiments tubes or other compartments as described herein may be configured to inflate in different directions. In some embodiments, tubes such as those described herein may be configured to deploy in a rearward direction, while in other embodiments such tubes may be configured to deploy laterally.

While FIGS. 4B and 4C depict an airbag 404 operably connected to only one inflation mechanism 408, FIG. 4D depicts an airbag 404 operably connected to a plurality of inflation mechanisms 408a, 408b, 408c, and 408d. Each one of the plurality of inflation mechanisms 408a, 408b, 408c, and 408d is operably connected to a corresponding set of tubes 412a, 412b, 412c, and 412d within the airbag 404. Such an embodiment may beneficially be controlled by a processor in communication with the inflation mechanisms 408a, 408b, 408c, and 408d. For example, if the processor determines, based on signals received from one or more sensors (such as the sensors 228 depicted in FIGS. 2A-2B), that a head 420 or knee 416 or other object is positioned in the deployment path of the airbag 404 (and, more specifically, in the deployment path of the tubes 412b and 412c), then the processor can cause the inflation mechanisms 408b and 408c to not inflate the tubes 412b and 412c, or to only partially inflate the tubes 412b and 412c. In this manner, the airbag 404 can be shaped to minimize the force of, or altogether prevent, an impact (and thus a resulting injury) by the airbag 404 on an out-of-position occupant or other object.

Although the airbag 404 is shown in FIGS. 4A-4D as having a plurality of tubes 412 that extend into the airbag 404 directly from the inflation mechanism 408, in other embodiments the inflation mechanism 408 may inject gas into a single tube or conduit that eventually divides into a plurality of tubes. The present disclosure encompasses the inclusion of any number of tubes 412 within an airbag 404. Moreover, each tube 412 may have any desired cross-sectional shape, and each tube 412 may take an undulating or circuitous path through the airbag 404 or a portion thereof rather than a straight path from one end of the airbag 404 to the other. In some embodiments, each tube 412 may be or comprise a compartment or chamber of the airbag 404. In still other embodiments, one tube or inflation path may split or divide into two or more tubes or inflation paths, so that if one tube or inflation path is blocked or pinched off, the incoming gas can inflate the other tubes or inflation paths. Further, although the airbag 408 is depicted as attached directly to the inflation mechanism 408, in some embodiments the airbag 408 may be spaced from and not directly attached to the inflation mechanism 408, and a duct, hose, or other conduit may channel gas from the inflation mechanism 408 to the airbag 404.

The inflation mechanism 408 may have a selectively variable (e.g., controllable) inflation pressure, so that the inflation mechanism 408 can control how rapidly the airbag fills. The inflation mechanism 408 may comprise just one inflator, or a plurality of inflators. In embodiments with a plurality of inflators, the inflation mechanism 408 may control the inflation pressure by igniting or otherwise triggering all or fewer than all of the plurality of inflators. In some embodiments, the inflation mechanism 408 may be configured to measure the gas pressure within the airbag, and to stop inflation thereof when the gas pressure reaches a predetermined threshold or exhibits a sudden spike (which may indicate, for example, that the airbag has inflated as much as it can within the available space). Although the inflation mechanism 408 is shown as operably attached only to the airbag 404, in some embodiments the inflation mechanism 408 may inflate a plurality of airbags. For example, if the airbag 404 or a similar airbag is used in the place of the airbag 312 in the embodiment of FIGS. 3A and 3B, the inflation mechanism 408 may be used to inflate both the airbag 404 and the airbag 304. Alternatively, each of the airbags 304 and 404 in such an embodiment may be operably connected to a separate inflation mechanism.

In some embodiments, an inflation mechanism 408 may comprise a mechanism or means to stop inflation once it has already begun (even in embodiments where inflation results from ignition of a chemical reaction). Any mechanism that can regulate the flow of gas from an otherwise closed volume may be used for this purpose. For inflation mechanisms that comprise a closed volume with one or more holes sized to achieve a specific rate and/or direction of gas release, a mechanism may be provided to close or otherwise control the size of the holes (e.g., the orifice diameter), so as to enable the rate and/or direction of gas release to be regulated or otherwise controlled. Additionally or alternatively, the inflation mechanism 408 may comprise a series of small inflators arranged in sequence, such that ignition of just one inflator will result in a given gas pressure within the airbag 404, while ignition of each successive inflator will result in development of a higher gas pressure. The pressure can thus be regulated by adjusting the number of inflators that are triggered, and inflation of the airbag 404 can be stopped by ceasing to ignite additional inflators.

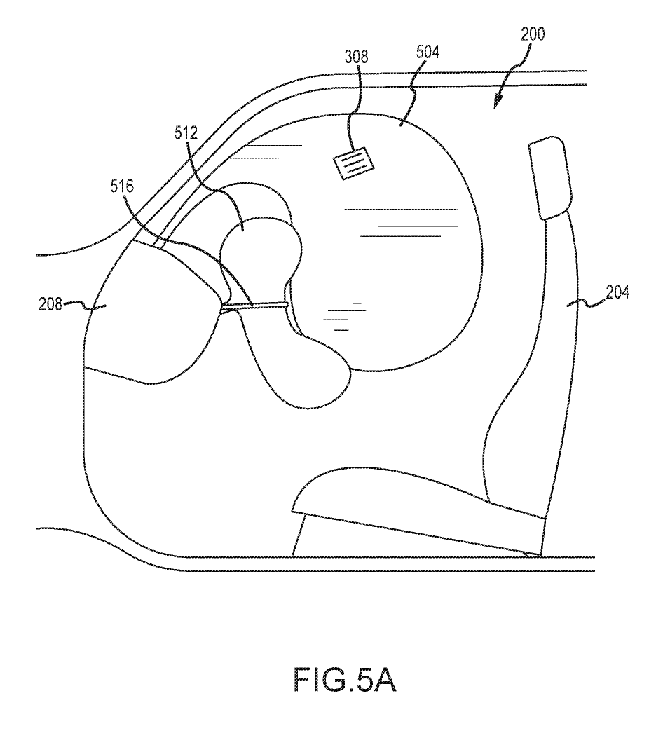

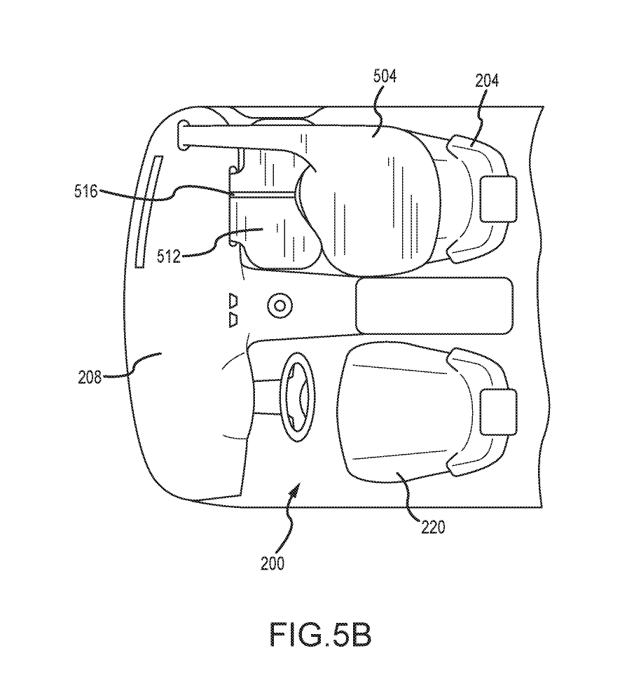

With reference now to FIGS. 5A and 5B, a vehicle such as the vehicle 100 may comprise a passenger compartment 200 configured with an instrument panel 208, a passenger seat 204, and a driver's seat 220. The embodiment of FIGS. 5A-5B comprises a passenger airbag system comprising an airbag 504 and an airbag 512. The airbag 504 is configured to deploy in the same (or in a substantially similar) manner as the airbag 304, and comprises a vent 308 that is the same as the vent 308 on the airbag 312. Similarly, the airbag 512 is configured to deploy in the same (or in a substantially similar) manner as the airbag 312. Unlike the airbags 304 and 312, however, the airbags 504 and 512 are configured with complementary shapes. More specifically, the airbag 512 comprises a shape that cradles the airbag 504 when both airbags are deployed. The portion of the airbag 512 that faces the airbag 504 and the passenger seat 204 may comprise any shape suitable for cradling the airbag 504, including, for example, a dish shape (e.g., a concave surface) or a V-shape. The airbag 504, meanwhile, may comprise a complementary shape, such as an inverse dish shape (e.g., a convex surface) or an inverse V-shape. The use of airbags 504 and 512 with complementary shapes beneficially provides stability to the airbag system. For example, if the airbag 504 is subjected to a non-longitudinal force (e.g., a force directed in other than the −X direction, with reference to the coordinate system 102 in FIG. 1), such as a force with a component along the Y or Z axes, then the cradling of the airbag 504 by the airbag 512 reduces the likelihood that the airbag 504 will slip off of the airbag 504, in which even the airbag 504 would no longer be supported by the airbag 512 and would likely not provide the needed protection to an occupant of the passenger seat 204. The complementary shaping therefore beneficially improves the safety of the passenger airbag system comprising the airbags 504 and 512.

Although in some embodiments the complementary shapes of the airbags 504 and 512 may be configured to ensure the airbag 504 does not move when a longitudinal force is exerted thereon in the −X direction, in other embodiments, the complementary shapes of the airbags 504 and 512 may be tuned, configured, or adjusted to purposefully cause the airbag 504 to move in a preferred direction when a longitudinal force is exerted thereon in the −X direction (e.g., in a direction toward a side curtain airbag or a central airbag between the passenger seat 204 and the driver's seat 220. In still other embodiments, the complementary shapes of the airbags 504 and 512 may be tuned, configured, or adjusted to minimize the chance of movement of the airbag 504 if a force is exerted thereon in a direction other than along the −X axis.

The airbag 512 may, in some embodiments, be manufactured to have the desired cradling shape, such that the airbag 512 will assume the cradling shape when it is fully inflated. In other embodiments, one or more tethers 516 may be used to limit the inflation of the airbag 512 so that it assumes a cradling shape. In still other embodiments, one or more tethers 516 may be used to selectively limit the inflation of the airbag 512. In yet other embodiments, the airbags 504 and 512 may be provided with a plurality of compartments, and the final shape of the airbag 504 and/or 512 may be adjusted by selectively inflating the compartments thereof.

For example, if the vehicle 100 comprising the passenger airbag system that includes the airbags 504 and 512 is involved in a collision that is not directly head-on, but rather has a lateral component as well, then the airbag 504 might deploy with tethers 516 to ensure that the airbag 512 cradles the airbag 504 and prevents the airbag 504 from being pushed off of the airbag 504 by a sideways force. Alternatively, the airbags 504 and 512 may comprise one or more compartments that are not inflated, so that the remaining compartment or compartments of the airbags 504 and 512 that are inflated have a complementary shape such as that depicted in FIGS. 5A and 5B. However, if the vehicle 100 is involved in a directly head-on collision (such that the exertion of a sideways force on the airbag 504 is unlikely), then the tethers 516 may be released, severed, or otherwise rendered inoperable, or all of the compartments of the airbags 504 and 512 may be inflated, so that each airbag 504 and 512 inflates to its as-manufactured shape. Tethers 516 may also be used to control the shape of the airbag 504, in the same manner as described with respect to the airbag 512.

Other devices and methods may also be used to ensure or adjust or tune the stability of a pair of airbags such as the airbags 304 and 312, and the airbags 504 and 512. For example, each airbag may be equipped with complementary Velcro or other hook-and-loop surfaces that interlock when the airbags are fully inflated. More generically, any two materials that, when in contact, will have a natural propensity for increased friction or interlocking may be applied to the surfaces (or a portion thereof) of the airbags 504 and 512, respectively. Additionally or alternatively, one or both airbags may be or comprise a friction-enhancing, non-slide surface treatment that increases the coefficient of friction between the two airbags and reduces the likelihood that one will slide off of the other in a collision. As yet another option, the airbags 304 and/or 504 may be prevented from moving laterally by one or more tethers that are secured both to the airbag 304 and/or 504, and to the instrument panel 208.

Many variations on the foregoing disclosure are possible. The tethers described herein may comprise, for example, a rope, an elongated section of airbag material, or a cable. Airbags according to embodiments of the present disclosure may deploy from other portions of the instrument panel besides those shown herein, and may also deploy, for example, from a central console of the vehicle 100, from a roof, frame, hinge pillar or door of the vehicle 100, or from a side of the passenger seat 204 (or of the driver's seat 220). Other deployment paths besides those described herein may also be used for one or both of a pair of airbags according to embodiments of the present disclosure. In some embodiments, one or both airbags in a pair of airbags such as the airbags 304 and 312 or 504 and 512 may comprise additional volumes or “wings” that extend the lateral reach of the airbag(s) beyond that illustrated herein. In some embodiments, more than two airbags may be used to further reduce the inflation pressure required to ensure that each airbag deploys in the necessary amount of time (and thus to further reduce the force with which such an airbag might impact an out-of-position occupant).

Although embodiments of the present disclosure have been described herein in the context of a front seat passenger airbag system, embodiments of the present disclosure may also be used in other areas of a vehicle such as the vehicle 100 to protect other occupants thereof

The airbags described herein, and airbags according to embodiments of the present disclosure generally, may have the same or different levels of rigidity, hardness, and/or structural integrity. For example, a first-deploying airbag such as the airbags 304 and 504 may be soft, while a second-deploying airbag such as the airbags 312 and 412 may be hard. Alternatively, the first-deploying airbag may be hard, and the second-deploying airbag may be soft. The first-deploying airbag may have a first strike “escape path” or deployment path that allows the first-deploying airbag to deploy without simultaneous deployment of the second-deploying airbag.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Embodiments include an airbag system for a vehicle, comprising: a first airbag configured to deploy along a non-linear path into a first volume in front of a vehicle seat; and a second airbag configured to deploy into a second volume in front of the first volume, the second volume positioned between, and adjacent to each of, the first volume and a vehicle interior surface, wherein the vehicle interior surface is positioned in front of the second volume.

Aspects of the above airbag system for a vehicle include: wherein the first airbag is configured to deploy from in front of the second volume, and further wherein the non-linear path comprises an upward portion, a rearward portion, and a downward portion; wherein the second airbag is configured to deploy into the second volume after the first airbag has deployed into the first volume; wherein the second airbag is configured to deploy along a second non-linear path; wherein at least one of the first airbag and the second airbag is configured to deploy in a lateral direction; wherein the first airbag is configured to deploy from a first position on an instrument panel, the second airbag is configured to deploy from a second position on the instrument panel, and the second position is closer to the vehicle seat than the first position; wherein the first position is laterally offset from the second position; wherein the first airbag is configured to have a first stand up time that is shorter than a second stand up time of the second airbag; wherein at least one of the first and second airbags comprises a plurality of tubes or compartments; and wherein one of the plurality of tubes or compartments can be inflated without inflating another of the plurality of tubes or compartments.

Embodiments also include a vehicle comprising: a passenger compartment comprising a forward structure, an occupant seat facing the forward structure, and an empty space separating the occupant seat from the forward structure; and an airbag system comprising: a first airbag comprising at least one vent and configured to deploy from a first storage compartment, along a non-linear path, into a first portion of the empty space, the first portion positioned between the occupant seat and the forward structure; a second airbag configured to deploy from a second storage compartment and into a second portion of the empty space, the second portion of the empty space positioned between the first portion and the forward structure; and at least one breakaway panel separating one of the first or second storage compartments from the empty space prior to deployment of the first and second airbags, the at least one breakaway panel configured to separate from the forward structure in a controlled manner so as to push an object resting on the at least one breakaway panel off to one side of the breakaway panel.

Aspects of the above vehicle include: wherein at least one of the first and second storage compartments is not located in the forward structure; wherein the airbag system further comprises a plurality of inflators configured to selectively inflate one of the first and second airbags; wherein the airbag system further comprises a plurality of sensors configured to detect a position of an object or occupant within the passenger compartment; wherein the first airbag has a first shape and the second airbag has a second shape configured to cradle the first shape; and wherein at least one of the first airbag and the second airbag comprises a non-slip surface configured to contact another of the first airbag and the second airbag.

Embodiments further include a method of protecting a vehicle occupant, comprising: receiving, at a processor, at least one signal from at least one sensor, the signal comprising information about an object or occupant in a vehicle passenger compartment; determining, with the processor and based on the information, a position of the object or occupant within the vehicle passenger compartment; adjusting a deployment parameter of one of a first airbag and a second airbag based on the determination; deploying the first airbag along a non-linear path into a first volume between a vehicle occupant and an internal vehicle surface; and deploying the second airbag into a second volume between the first volume and the vehicle surface, the deploying the second airbag occurring after a time delay following the deploying of the first airbag.

Aspects of the above method of protecting a vehicle occupant include: wherein the first airbag is deployed from a first location, and the second airbag is deployed from a second location closer to the occupant than the first location; wherein the adjusting the deployment parameter comprises adjusting the rate of inflation of the one of the first airbag and the second airbag; and wherein the adjusting the deployment parameter comprises adjusting which of a plurality of internal compartments within the one of the first airbag and the second airbag will be inflated.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The terms “memory” and “computer-readable memory” are used interchangeably and, as used herein, refer to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable medium is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, and ARM® Cortex-A and ARM926EJ-S™ processors. A processor as disclosed herein may perform computational functions using any known or future-developed standard, instruction set, libraries, and/or architecture.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

What is claimed is:

1. An airbag system for a vehicle, comprising:
a first airbag configured to deploy along a non-linear path into a first volume in front of a vehicle seat; and
a second airbag configured to deploy into a second volume in front of the first volume, the second volume positioned between, and adjacent to each of, the first volume and a vehicle interior surface,
wherein the vehicle interior surface is positioned in front of the second volume.

2. The airbag system of claim 1, wherein the first airbag is configured to deploy from in front of the second volume, and further wherein the non-linear path comprises an upward portion, a rearward portion, and a downward portion.

3. The airbag system of claim 1, wherein the second airbag is configured to deploy into the second volume after the first airbag has deployed into the first volume.

4. The airbag system of claim 1, wherein the second airbag is configured to deploy along a second non-linear path.

5. The airbag system of claim 1, wherein at least one of the first airbag and the second airbag is configured to deploy in a lateral direction.

6. The airbag system of claim 5, wherein the first airbag is configured to deploy from a first position on an instrument panel, the second airbag is configured to deploy from a second position on the instrument panel, and the second position is closer to the vehicle seat than the first position.

7. The airbag system of 6, wherein the first position is laterally offset from the second position.

8. The airbag system of claim 1, wherein the first airbag is configured to have a first stand up time that is shorter than a second stand up time of the second airbag.

9. The airbag system of claim 1, wherein at least one of the first and second airbags comprises a plurality of tubes or compartments.

10. The airbag system of claim 9, wherein one of the plurality of tubes or compartments can be inflated without inflating another of the plurality of tubes or compartments.

11. A vehicle comprising:
a passenger compartment comprising a forward structure, an occupant seat facing the forward structure, and an empty space separating the occupant seat from the forward structure; and
an airbag system comprising:
a first airbag comprising at least one vent and configured to deploy from a first storage compartment, along a non-linear path, into a first portion of the empty space, the first portion positioned between the occupant seat and the forward structure;
a second airbag configured to deploy from a second storage compartment and into a second portion of the empty space, the second portion of the empty space positioned between the first portion and the forward structure; and
at least one breakaway panel separating one of the first or second storage compartments from the empty space prior to deployment of the first and second airbags, the at least one breakaway panel configured to separate from the forward structure in a controlled manner so as to push an object resting on the at least one breakaway panel off to one side of the breakaway panel.

12. The vehicle of claim 11, wherein at least one of the first and second storage compartments is not located in the forward structure.

13. The vehicle of claim 11, wherein the airbag system further comprises a plurality of inflators configured to selectively inflate one of the first and second airbags.

14. The vehicle of claim 11, wherein the airbag system further comprises a plurality of sensors configured to detect a position of an object or occupant within the passenger compartment.

15. The vehicle of claim 11, wherein the first airbag has a first shape and the second airbag has a second shape configured to cradle the first shape.

16. The vehicle of claim 11, wherein at least one of the first airbag and the second airbag comprises a non-slip surface configured to contact another of the first airbag and the second airbag.

17. A method of protecting a vehicle occupant, comprising:
receiving, at a processor, at least one signal from at least one sensor, the signal comprising information about an object or occupant in a vehicle passenger compartment;
determining, with the processor and based on the information, a position of the object or occupant within the vehicle passenger compartment;
adjusting a deployment parameter of one of a first airbag and a second airbag based on the determination;
deploying the first airbag along a non-linear path into a first volume between a vehicle occupant and an internal vehicle surface; and
deploying the second airbag into a second volume between the first volume and the vehicle surface, the deploying the second airbag occurring after a time delay following the deploying of the first airbag.

18. The method of claim 17, wherein the first airbag is deployed from a first location, and the second airbag is deployed from a second location closer to the occupant than the first location.

19. The method of claim 17, wherein the adjusting the deployment parameter comprises adjusting the rate of inflation of the one of the first airbag and the second airbag.

20. The method of claim 17, wherein the adjusting the deployment parameter comprises adjusting which of a plurality of internal compartments within the one of the first airbag and the second airbag will be inflated.
